(19) United States
(12) Patent Application Publication
(10) Pub. No.: US 2021/0396967 A1
(43) Pub. Date: Dec. 23, 2021

(54) OPTICAL LENSE AND ELECTRONIC DEVICE HAVING THE SAME

(71) Applicant: HON HAI PRECISION INDUSTRY CO., LTD., New Taipei (TW)

(72) Inventors: YI-TING LIN, New Taipei (TW); CHUN-CHENG KO, New Taipei (TW)

(21) Appl. No.: 17/238,810

(22) Filed: Apr. 23, 2021

(30) Foreign Application Priority Data
Jun. 23, 2020 (CN) 202010582970.2

(51) Int. Cl. G02B 13/00; G02B 9/64

(52) U.S. Cl. CPC G02B 13/0045; G02B 9/64

(57) ABSTRACT

An optical lens made from plastic materials which is able to gather more light to register on a high-resolution image sensor of an image-capturing device includes first to seventh lenses. The first to seventh lenses of the optical lens meets conditions of composite formula:

5.09<(EFL1/EFL2)*(EFL3/EFL4)*(EFL5/EFL6)*EFL7<−4.92;

1.1<(EFL1+EFL2+EFL3)/EFL4<1.3; −0.4<(EFL5+EFL6+EFL7)/EFL4<−0.3;

0.75<(T1\hat{ }2+T5\hat{ }2)\hat{ }0.5<0.85.

EFL1, EFL2, EFL3, EFL4, EFL5, EFL6, and EFL7 are respective focal lengths of the first to seventh lenses, and T1, T5 are thicknesses of the first lens and the fifth lens.

### FIELD

The subject matter herein generally relates to imaging in electronic devices.

### BACKGROUND

The camera function of mobile phones has high resolution and wide angle of view. With the increasingly sophisticated semiconductor manufacturing process, the resolution of mobile phone photos has been improved by reducing the size of pixels of the image detector. However, it is necessary to increase the amount of light and the MTF of the edge area of imaging sensor to obtain clear images.

Light-passing value of aperture of the lens or the number of lenses or the wider angle of view are employed to obtain the clearer images. However, such ways increase the manufacturing cost of the optical lens and the size of the optical lens.

### BRIEF DESCRIPTION OF THE DRAWINGS

Implementations of the present disclosure will now be described, by way of embodiments, with reference to the attached figures.

FIG. 1 is a schematic structural diagram of an optical lens according to the present disclosure.

FIG. 2 is a diagram of characteristic curve of visible light of imaging field curvatures of a first embodiment of the lens in FIG. 1.

FIG. 3 is a diagram of visible light distortion characteristics of the lens in FIG. 1.

FIG. 4 is a diagram of characteristic curve of visible light of imaging field curvatures of a second embodiment of a lens.

FIG. 5 is a diagram of visible light distortion characteristics of the second embodiment of the lens.

FIG. 6 is a diagram of structure of an electronic device employing the disclosed lens.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “comprising” means “including, but not necessarily limited to”; it specifically indicates open-ended inclusion or membership in a so-described combination, group, series, and the like.

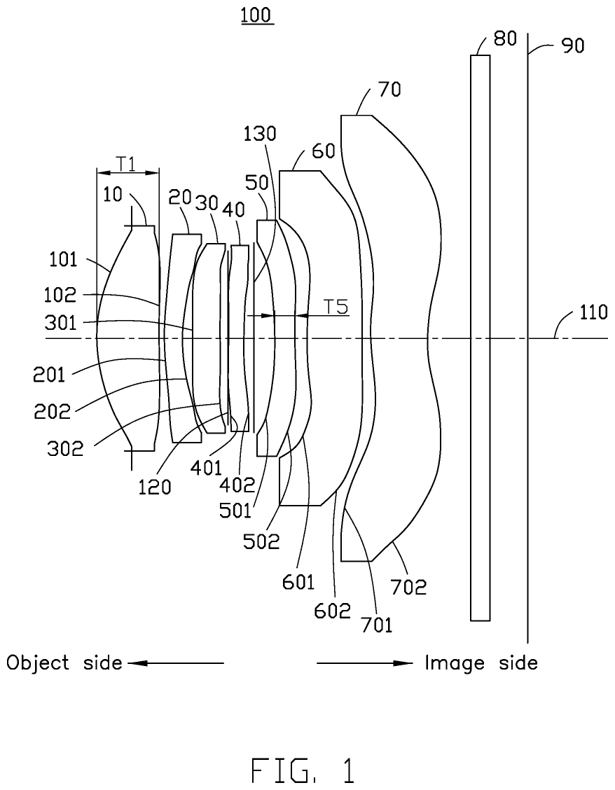

Referring to FIG. 1, the optical lens 100 includes a first lens 10, a second lens 20, a diaphragm 90, a third lens 30, a fourth lens 40, a fifth lens 50, a sixth lens 60, a seventh lens 70, a filter 80, and an image plane 90 arranged in order from the object side to the image side.

The optical lens 100 has an optical axis 110. The first to seventh lenses 10 to 70, the stop 90, the filter 80, and the image plane 90 are all arranged symmetrically about the optical axis 110. The material of each of the first to seventh lenses 10 to 70 is plastic.

The first lens 10 is an aspherical lens. The first lens 10 includes a first surface 101 adjacent to the object side and a second surface 102 adjacent to the image side. The first surface 101 is convex surface protruding toward the object side, and the second surface 102 is a convex surface protruding toward the image side. The curvature of the first surface 101 is greater than the curvature of the second surface 102.

The second lens 20 is an aspherical lens. The second lens 20 includes a third surface 201 adjacent to the second surface 102 and a fourth surface 202 adjacent to the image side. The third surface 201 is a convex surface protruding toward the object side, and the fourth surface 202 is convex surface protruding toward the object side.

The third lens 30 is an aspherical lens. The third lens 30 includes a fifth surface 301 adjacent to the fourth surface 202 and a sixth surface 302 adjacent to the image side. The fifth surface 301 is a convex surface protruding toward the object side, and the sixth surface 302 is convex surface protruding toward the object side.

The fourth lens 40 is an aspherical lens. The fourth lens 40 includes a seventh surface 401 adjacent to the sixth surface 302 and an eighth surface 402 adjacent to the image side. The seventh surface 401 is convex surface protruding toward the object side, and the eighth surface 402 is convex surface protruding toward the object side.

A first aperture 120 is located between the third lens 30 and the fourth lens 40 and is positioned on the optical axis 110. The first aperture 120 is closer to the seventh surface 401 than to the sixth surface 302.

The fifth lens 50 is an aspherical lens. The fifth lens 50 includes a ninth surface 501 adjacent to the eighth surface 402 and a tenth surface 502 adjacent to the image side. The ninth surface 501 is convex surface protruding toward the image side, and the tenth surface 502 is convex surface protruding toward the image side.

A second aperture 130 is located between the fourth lens 40 and the fifth lens 50 and is positioned on the optical axis 110. The second aperture 130 is closer to the eighth surface 402 than to the ninth surface 501.

The sixth lens 60 is an aspherical lens. The sixth lens 60 includes an eleventh surface 601 adjacent to the tenth surface 502 and a twelfth surface 602 adjacent to the image side. The eleventh surface 601 is convex surface protruding toward the image side, and the twelfth surface 602 is convex surface protruding toward the image side.

The seventh lens 70 is an aspherical lens. The seventh lens 70 includes a thirteenth surface 701 adjacent to the twelfth surface 602 and a fourteenth surface 702 adjacent to the image side. At the optical axis 110, the thirteenth surface 701 and the fourteenth surface 702 both protrude toward the object side, but at edges of the seventh lens 70 away from the optical axis 110, the thirteenth surface 701 and the fourteenth surface 702 both protrude toward the image side. The seventh lens 70 thus has an M shape.

The filter 80 is used to filter out the infrared light in the light passing through the seventh lens 70 so as to improve quality of images on the image plane 90.

The image plane 90 is used for imaging.

In the embodiment, the optical lens 100 meets the conditions of following formulas:

−5.09<(EFL1/EFL2)*(EFL3/EFL4)*(EFL5/EFL6)*EFL7<−4.92;

1.1<(EFL1+EFL2+EFL3)/EFL4<1.3;

−0.4<(EFL5+EFL6+EFL7)/EFL4<−0.3;

0.75<(T1\hat{ }2+T5\hat{ }2)\hat{ }0.5<0.85;

Wherein, EFL1 is the equivalent focal length of the first lens 10; EFL2 is the equivalent focal length of the second lens 20; EFL3 is the equivalent focal length of the third lens 30; EFL4 is the equivalent focal length of the fourth lens 40; EFL5 is the equivalent focal length of the fifth lens 50; EFL6 is the equivalent focal length of the sixth lens 60; EFL7 is the equivalent focal length of the seventh lens 70; T1 is the thickness of the first lens 10; T5 is the thickness of the fifth lens 50.

The optical lens 100 will be further illustrated in different embodiments:

### First Embodiment

The following tables 1-3 respectively show some parameters of the optical lens 100 in the first embodiment. In table 1, R represents the radius of curvature of the corresponding surface, and T represents the thickness of the corresponding lens.

By satisfying the above formulas 1-4 and conditions of formulas with values as shown in tables 1-3, the first surface 101, the second surface 102, the third surface 201, the fourth surface 202, the fifth surface 301, the sixth surface 302, the seventh surface 401, the eighth surface 402, the ninth surface 501, the tenth surface 502, the eleventh surface 601, the twelfth surface 602, the thirteenth surface 701, and the fourteenth surfaces 702 corresponding to the first lens 10, the second lens 20, and the third lens 30, the fourth lens 40, the fifth lens 50, the sixth lens 60 and the seventh lens 70 and can be created. All surfaces are aspherical.

TABLE 1

| | | Radius of | |
|---|---|---|---|
| surface | Types | curvature (mm) | thickness (mm) |
| First surface | Aspherical | 1.861 | 0.72 |
| Second surface | Aspherical | −5.084 | 0.05 |
| third surface | Aspherical | 5.202 | 0.22 |
| fourth surface | Aspherical | 8.277 | 0.12 |
| fifth surface | Aspherical | −5.198 | 0.32 |
| sixth surface | Aspherical | 52.139 | 0.05 |
| first aperture | flat | gigantic | |
| seventh surface | Aspherical | −5.084 | 0.05 |
| eighth surface | Aspherical | 5.202 | 0.22 |
| second aperture | flat | gigantic | |
| ninth surface | Aspherical | −15.642 | 0.25 |
| tenth surface | Aspherical | 9.606 | 0.13 |
| eleventh surface | Aspherical | −0.556 | 0.64 |
| twelfth surface | Aspherical | −1.039 | 0.1 |
| thirteenth surface | Aspherical | −0.681 | 0.66 |
| fourteenth surface | Aspherical | 1.739 | 0.5 |
| filter | flat | | 0.21 |
| Image plane | flat | | 0.45 |

TABLE 2

| Aspheric | first | second | third | fourth | fifth | sixth | seventh |
|---|---|---|---|---|---|---|---|
| coefficient | surface | surface | surface | surface | surface | surface | surface |
| A2 | −3.836E−03 | 0.10398 | 0.06466 | 0.19364 | 0.07917 | −0.05459 | 0.01257 |
| A₄ | −1.297E−03 | −0.01136 | −0.06940 | −0.05367 | 0.03067 | 0.04423 | 0.01057 |
| A₆ | −0.01632 | −6.18E−03 | −0.04481 | −0.02073 | 0.07351 | −3.664E−03 | −0.06144 |
| A₈ | 0.01001 | −4.088E−05 | 0.02832 | −0.03886 | −0.01236 | 0.041 | 2.719E−03 |
| A₁₀ | −7.628E−03 | −1.383E−03 | 6.9592E−03 | 0.04557 | −0.01029 | 0.08012 | 2.387E−03 |
| A₁₂ | 0 | 0 | −2.865E−03 | −5.704E−03 | 0.01004 | 0.07205 | 1.289E−03 |
| A₁₄ | 0 | 0 | 0 | 0 | 0 | 0 | 0 |
| A₁₆ | 0 | 0 | 0 | 0 | 0 | 0 | 0 |

| Aspheric | eighth | ninth | tenth | eleventh | twelfth | thirteenth | fourteenth |
|---|---|---|---|---|---|---|---|
| coefficient | surface | surface | surface | surface | surface | surface | surface |
| A2 | −0.04072 | 1.0956E−03 | 0.03363 | 0.95668 | 0.41248 | 0.91874 | 0.02977 |
| A4 | −0.01581 | −0.24184 | −0.22428 | −0.52125 | 1.11E−3 | −0.571 | −0.13934 |
| A6 | −0.04308 | 0.24766 | −0.10518 | 0.22167 | −0.09012 | 0.29806 | 0.06314 |
| A8 | −7.339E−03 | −0.09042 | 0.41224 | −0.05978 | 0.06338 | −0.11481 | −0.02210 |
| A10 | −0.03403 | −0.03156 | −0.43356 | −0.07237 | −0.02859 | 0.03014 | 4755E−03 |
| A12 | 0.01684 | −0.01117 | 0.25286 | 0.10086 | 8.018E−03 | −5.34E−03 | −5.78E−04 |
| A14 | 0 | 0.05655 | −0.07849 | −0.05364 | −1.28E−03 | 5.14E−04 | 3.53E−05 |
| A16 | 0 | −0.02925 | 9.51E−03 | 0.01054 | 9.13E−05 | −2.1E−05 | −7.97E−07 |

TABLE 3

| | | MTF (Modulation Transfer | |
|---|---|---|---|
| | | function)(100 lp/m) | MTF (100 lp/m) |
| F/NO | FOV(2ω) | Central field of view | Corner field of view |
| 1.6 | 80° | >79 | >50 |

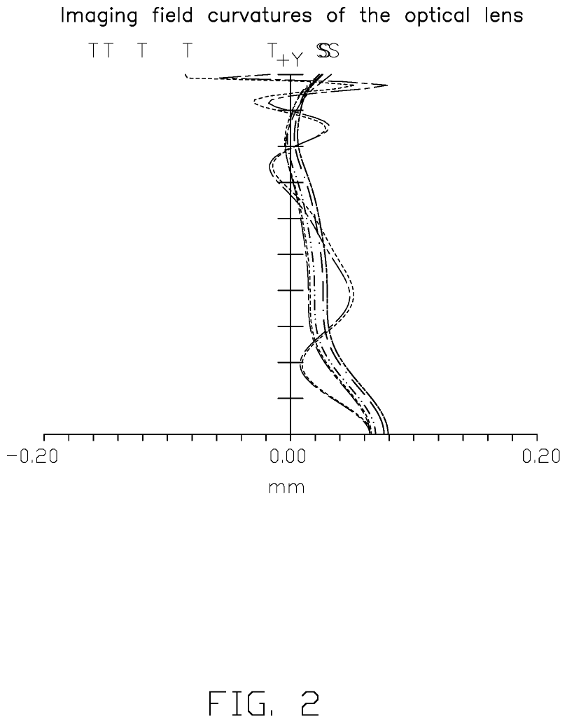

FIG. 2 shows characteristic curve of visible light imaging field curvatures of the optical lens 100 in a first embodiment. The curves T and S are the characteristic curve of tangential field curvature and the characteristic curve of sagittal field curvature. It can be seen from FIG. 2 that values of the tangential field curvature and the sagittal field curvature of the optical lens 100 in the first embodiment are within the range of 0.08 mm to −0.1 mm.

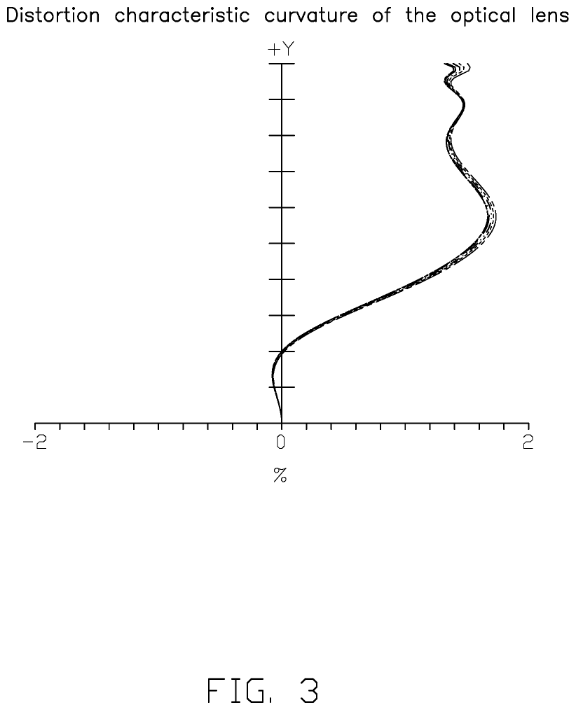

FIG. 3 is a visible light distortion characteristic curvature of the optical lens 100 in the first embodiment. It can be seen that the amount of distortion of the optical lens in the first embodiment is within 0%-2%.

### Second Embodiment

The following tables 4-6 respectively show some parameters of the optical lens 100 in the second embodiment. In Table 4, R represents the radius of curvature of the corresponding surface, and T represents the thickness of the corresponding lens.

By satisfying the above formulas 1-4 and conditions of formulas with values as shown in Tables 4-6, the first surface 101, the second surface 102, the third surface 201, the fourth surface 202, the fifth surface 301, the sixth surface 302, the seventh surface 401, the eighth surface 402, the ninth surface 501, the tenth surface 502, the eleventh surface 601, the twelfth surface 602, the thirteenth surface 701, and the fourteenth surfaces 702 corresponding to the first lens 10, the second lens 20, and the third lens 30, the fourth lens 40, the fifth lens 50, the sixth lens 60 and the seventh lens 70 and can be created. All surfaces are aspherical.

TABLE 4

| | | Radius of | |
|---|---|---|---|
| surface | Types | curvature (mm) | thickness (mm) |
| First surface | Aspherical | 1.881 | 0.799 |
| Second surface | Aspherical | −5.103 | 0.05 |
| third surface | Aspherical | 6.324 | 0.22 |
| fourth surface | Aspherical | 11.835 | 0.12 |
| fifth surface | Aspherical | −5.054 | 0.32 |
| sixth surface | Aspherical | −143.12 | 0.05 |
| first aperture | flat | gigantic | |
| seventh surface | Aspherical | 4.407 | 0.22 |
| eighth surface | Aspherical | 3.83 | 0.12 |
| second aperture | flat | gigantic | |
| ninth surface | Aspherical | −19.314 | 0.268 |
| tenth surface | Aspherical | 10.121 | 0.13 |
| eleventh surface | Aspherical | −0.558 | 0.64 |
| twelfth surface | Aspherical | −1.082 | 0.1 |
| thirteenth surface | Aspherical | −0.627 | 0.66 |
| fourteenth surface | Aspherical | 2.097 | 0.4 |
| filter | flat | gigantic | 0.21 |
| Image plane | flat | gigantic | 0.45 |

TABLE 5

| Aspheric | first | second | third | fourth | fifth | sixth | seventh |
|---|---|---|---|---|---|---|---|
| coefficient | surface | surface | surface | surface | surface | surface | surface |
| A2 | −9.86E−04 | 0.1052 | 0.063 | 0.1908 | 0.0852 | −0.0593 | 3.979E−03 |
| A₄ | −1.57E−03 | −0.0123 | −0.0635 | −0.0468 | 0.02523 | 0.05154 | 7.89E−03 |
| A₆ | −0.0155 | −5.02E−03 | −0.0423 | −0.0218 | 0.0675 | 2.36E−03 | −0.0551 |
| A₈ | 9.46E−03 | −1.1E−03 | 0.0277 | −0.0394 | −8.06E−3 | 0.0322 | 8.42E−03 |
| A₁₀ | −6.33E−03 | −5.72E−04 | 5.3E−03 | 0.05 | −8.5E−03 | 0.074 | −3.62E−04 |
| A₁₂ | 0 | 0 | −2.42E−03 | −8.34E−03 | 8.6E−03 | −0.0652 | −2.16E−03 |
| A₁₄ | 0 | 0 | 0 | 0 | 0 | 0 | 0 |
| A₁₆ | 0 | 0 | 0 | 0 | 0 | −0 | 0 |

| Aspheric | eighth | ninth | tenth | eleventh | twelfth | thirteenth | fourteenth |
|---|---|---|---|---|---|---|---|
| coefficient | surface | surface | surface | surface | surface | surface | surface |
| A2 | −0.0356 | 6.18E−03 | 0.023 | 0.9513 | 0.4125 | 0.9557 | 0.07575 |
| A4 | −0.0346 | −0.21 | −0.204 | −0.5222 | −5.53E−03 | −0.567 | −0.144 |
| A6 | −0.0321 | 0.2166 | −0.1133 | 0.2133 | −0.0886 | 0.2973 | 0.06328 |
| A8 | −9.33E−03 | −0.102 | 0.4 | −0.06 | 0.0636 | −0.11484 | −0.0221 |
| A10 | −0.0322 | −0.0172 | −0.432 | −0.072 | −0.0286 | 0.03105 | 4.753E−03 |
| A12 | 0.01323 | −9.45E−03 | 0.2562 | 0.1012 | 8.02E−03 | −5.37E−03 | −5.77E−04 |
| A14 | 0 | 0.04926 | −0.07773 | −0.0534 | −1.28E−03 | 5.14E−04 | 3.534E−05 |
| A16 | 0 | −0.0264 | 8.815E−03 | 0.01049 | 8.99E−05 | −2.1E−05 | −7.983E−07 |

TABLE 6

| | | MTF (Modulation Transfer | |
|---|---|---|---|
| | | function)(100 lp/m) | MTF (100 lp/m) |
| F/NO | FOV(2ω) | Central field of view | Corner field of view |
| 1.57 | 80° | >80 | >40 |

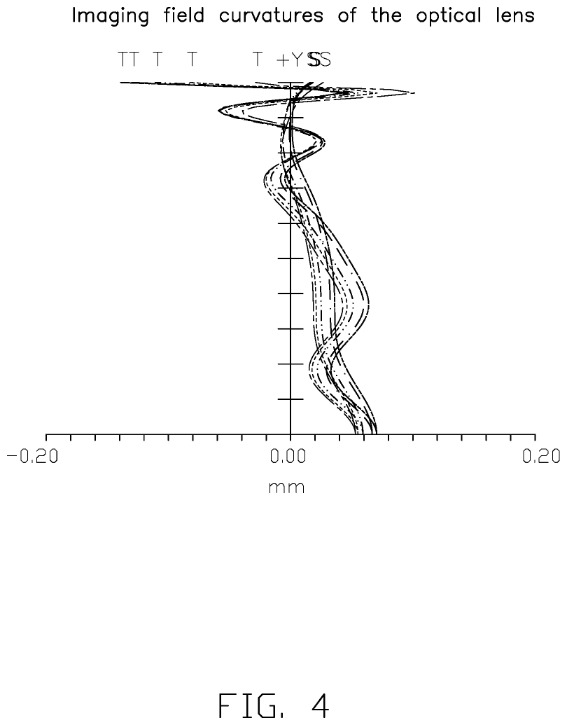

FIG. 4 shows a characteristic curve of visible light imaging field curvatures of the optical lens 100 in a second embodiment. The curves T and S are the characteristic curve of tangential field curvature and the characteristic curve of sagittal field curvature. It can be seen from FIG. 2 that values of the tangential field curvature and the sagittal field curvature of the optical lens 100 in the second embodiment are within the range of 0.06 mm˜−0.18 mm.

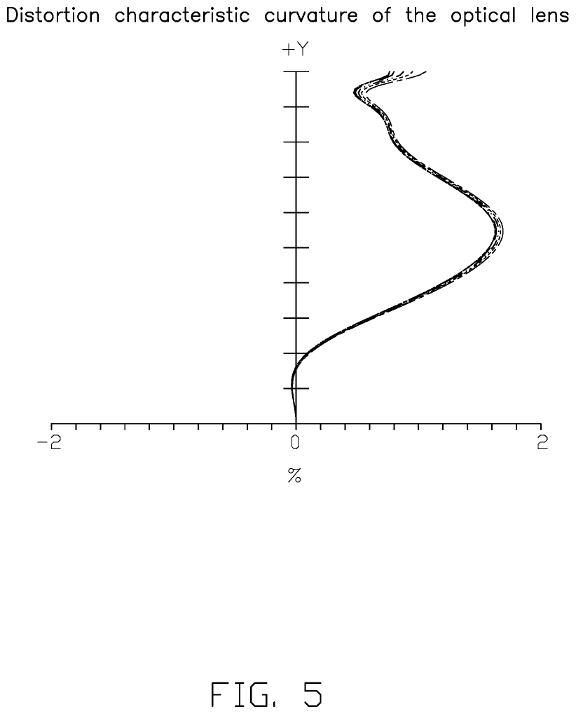

FIG. 5 is a visible light distortion characteristic curvature of the optical lens 100 in the second embodiment. It can be seen that the amount of distortion of the optical lens in the second embodiment is within 0%˜1.8%.

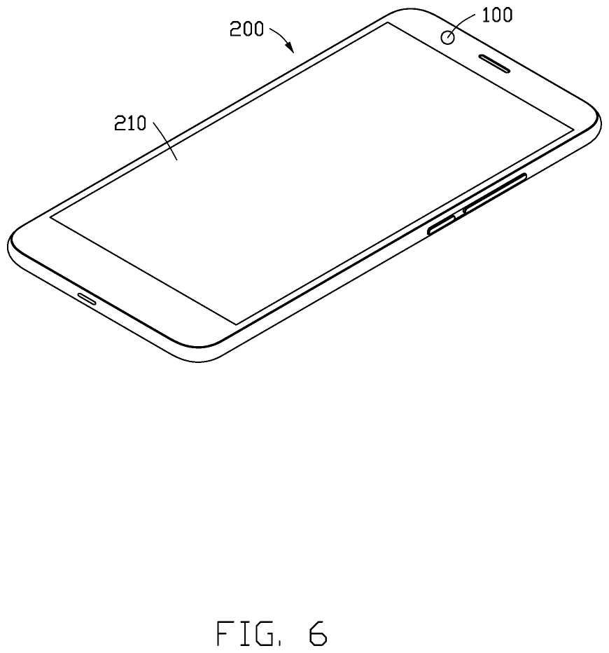

Referring to FIG. 6, an electronic device 200 is also disclosed. The electronic device 200 includes a body 210. The electronic device 200 further includes at least one optical lens 100 positioned in the body 210.

The optical lens 100 and electronic device 200 correct aberrations by satisfying the conditions of above formula 1-4, so as to improve the imaging quality of the optical lens 100, reducing the manufacturing cost of the optical lens 100, and reducing the overall size of the optical lens 100.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure, up to and including the full extent established by the broad general meaning of the terms used in the claims.

What is claimed is:

1. A optical lens comprising:
a first lens;
a second lens;
a third lens;
a fourth lens;
a fifth lens;
a sixth lens;
a seventh lens;
wherein the optical lens defines an optical axis, the first lens, the second lens, the third lens, the fourth lens, the fifth lens, the sixth lens and the seventh lens are arranged in order from an object side to an image side along the optical axis, the optical lens meets the conditional formulas as follows:
−5.09<(EFL1/EFL2)*(EFL3/EFL4)*(EFL5/EFL6)*EFL7<−4.92;
1.1<(EFL1+EFL2+EFL3)/EFL4<1.3;
−0.4<(EFL5+EFL6+EFL7)/EFL4<−0.3;
0.75<(T1\hat{ }2+T5\hat{ }2)\hat{ }0.5<0.85;
wherein EFL1 is an equivalent focal length of the first lens 10; EFL2 is an equivalent focal length of the second lens 20; EFL3 is an equivalent focal length of the third lens 30; EFL4 is an equivalent focal length of the fourth lens 40; EFL5 is an equivalent focal length of the fifth lens 50; EFL6 is an equivalent focal length of the sixth lens 60; EFL7 is an equivalent focal length of the seventh lens 70; T1 is a thickness of the first lens 10; T5 is a thickness of the fifth lens.

2. The optical lens of claim 1, wherein the first lens, the second lens, the third lens, the fourth lens, the fifth lens, the sixth lens and the seventh lens are aspheric lenses.

3. The optical lens of claim 2, wherein the seventh lens comprises two surfaces respectively facing the object side and the image side, a part of the two surfaces at the position of the optical axis both protrude toward the object side, and a part of the two surfaces at two edges of the seventh lens away from the optical axis both protrude toward the image side, the seventh lens is M shaped.

4. The optical lens of claim 3, wherein the first lens comprises a first surface adjacent to the object side and a second surface adjacent to the image side, the first surface is a convex surface protruding toward the object side, and the second surface is a convex surface protruding toward the image side, the curvature of the first surface is greater than the curvature of the second surface.

5. The optical lens of claim 1, wherein the material of each of the first lens, the second lens, the third lens, the fourth lens, the fifth lens, the sixth lens and the seventh lens is plastic.

6. The optical lens of claim 1, wherein the optical lens further comprises a first aperture between the third lens and the fourth lens and a second aperture between the fourth lens and the fifth lens, the third lens, the first aperture, the fourth lens, the second aperture, and the fifth lens are arranged at intervals.

7. The optical lens of claim 6, wherein an aperture value of the optical lens is 1.6 and a central field of view of the optical lens is 80°.

8. The optical lens of claim 1, wherein the optical lens further comprises a filter located a side of the seventh lens away from the sixth lens, the seventh lens element and the filter are arranged at intervals.

9. The optical lens of claim 8, wherein the optical lens further comprises an image plane located a side the filter way from the seventh lens, the filter and the image plane are arranged at intervals.

10. An electronic device comprising:
a body;
an optical lens positioned in the body and comprising a f first lens, a second lens, a third lens, a fourth lens, a fifth lens, a sixth lens, a seventh lens;
wherein the optical lens defines an optical axis, the first lens, the second lens, the third lens, the fourth lens, the fifth lens, the sixth lens and the seventh lens are arranged in order from an object side to an image side along the optical axis, the optical lens meets the conditional formulas as follows:
−5.09<(EFL1/EFL2)*(EFL3/EFL4)*(EFL5/EFL6)*EFL7<−4.92;
1.1<(EFL1+EFL2+EFL3)/EFL4<1.3;
−0.4<(EFL5+EFL6+EFL7)/EFL4<−0.3;
0.75<(T1\hat{ }2+T5\hat{ }2)\hat{ }0.5<0.85;
wherein EFL1 is an equivalent focal length of the first lens 10; EFL2 is an equivalent focal length of the second lens 20; EFL3 is an the equivalent focal length of the third lens 30; EFL4 is an equivalent focal length of the fourth lens 40; EFL5 is an equivalent focal length of the fifth lens 50; EFL6 is an equivalent focal length of the sixth lens 60; EFL7 is an equivalent focal length of the seventh lens 70; T1 is a thickness of the first lens 10; T5 is a thickness of the fifth lens.

11. The electronic device of claim 10, wherein the first lens, the second lens, the third lens, the fourth lens, the fifth lens, the sixth lens and the seventh lens are aspheric lenses.

12. The electronic device of claim 11, wherein the seventh lens comprises two surfaces respectively facing the object side and the image side, a part of the two surfaces at the position of the optical axis both protrude toward the object side, and a part of the two surfaces at two edges of the seventh lens away from the optical axis both protrude toward the image side, the seventh lens is M shaped.

13. The electronic device of claim 12, wherein the first lens comprises a first surface adjacent to the object side and a second surface adjacent to the image side, the first surface is a convex surface protruding toward the object side, and the second surface is a convex surface protruding toward the image side, the curvature of the first surface is greater than the curvature of the second surface.

14. The electronic device of claim 10, wherein the material of each of the first lens, the second lens, the third lens, the fourth lens, the fifth lens, the sixth lens and the seventh lens is plastic.

15. The electronic device of claim 10, wherein the optical lens further comprises a first aperture between the third lens and the fourth lens and a second aperture between the fourth lens and the fifth lens, the third lens, the first aperture, the fourth lens, the second aperture, and the fifth lens are arranged at intervals.

16. The electronic device of claim 15, wherein an aperture value of the optical lens is 1.6 and a central field of view of the optical lens is 80°.

17. The electronic device of claim 10, wherein the optical lens further comprises a filter located a side of the seventh lens away from the sixth lens, the seventh lens element and the filter are arranged at intervals.

18. The electronic device of claim 17, wherein the optical lens further comprises an image plane located a side the filter way from the seventh lens, the filter and the image plane are arranged at intervals.
